(19) United States
(12) Patent Application Publication
(10) Pub. No.: US 2025/0028124 A1
(43) Pub. Date: Jan. 23, 2025

(54) OPTICAL-FIBER ADAPTER

(71) Applicant: ACON OPTICS COMMUNICATIONS INC., New Taipei City (TW)

(72) Inventors: Jia-Rong Wu, New Taipei City (TW); Tsung-Yao Hsu, New Taipei City (TW)

(21) Appl. No.: 18/771,679

(22) Filed: Jul. 12, 2024

(30) Foreign Application Priority Data
Jul. 18, 2023 (TW) 112207499

(51) Int. Cl. G02B 6/38

(52) U.S. Cl. CPC G02B 6/3825

(57) ABSTRACT

An optical-fiber adapter includes a base member and a door piece. The base member has a receiving groove and an insertion opening and includes a doorstop portion. The insertion opening is in communication with the receiving groove, and the doorstop portion is at a bottom portion of the insertion opening. The door piece is in the receiving groove to selectively close or open the insertion opening. Each of two sides of the door piece has a pivot portion, each of the pivot portions is adjacent to the doorstop portion and pivotally connected to a corresponding one of two side walls of the base member, and an outer surface of the door piece includes a protrusion adjacent to the doorstop portion. When the optical-fiber plug is inserted into the receiving groove of the optical-fiber adapter, the protrusion abuts against the bottom surface of the connection body of the optical-fiber plug.

### CROSS-REFERENCE TO RELATED APPLICATION

This non-provisional application claims priority under 35 U.S.C. § 119 (a) to patent application No. 112207499 filed in Taiwan, R.O.C. on Jul. 18, 2023, the entire contents of which are hereby incorporated by reference.

### FIELD OF THE INVENTION

The instant disclosure relates to an adapter, and more particular to an optical-fiber adapter.

### BACKGROUND

The optical fiber inside an optical-fiber adapter, as known to the inventor, can be coupled to an optical path of a mating component. The optical-fiber adapter is adapted to be mated with an optical-fiber plug. Moreover, in order to prevent dust from entering the optical-fiber adapter and affecting the performance of the optical fiber inside the optical-fiber adapter, a movable door piece is pivotally connected to the body of the optical-fiber adapter.

Please refer to FIG. 1. FIG. 1 illustrates a lateral cross-sectional view showing an optical-fiber adapter A and an optical-fiber plug B of a prior art known to the inventor are mated with each other. The optical-fiber adapter A has a mating cavity A1 for being inserted by the optical-fiber plug B. A doorstop portion A4 is at a bottom portion of an opening A2 of the mating cavity A1, and the shaft portions A51 at two sides of a door piece A5 are pivotally connected to a portion of the optical-fiber adapter adjacent to the doorstop portion A4. A bottom portion of the main body B1 of the optical-fiber plug B has a recessed portion B4. When the optical-fiber plug B is inserted into the mating cavity A1, the optical-fiber plug B drops toward the bottom portion of the mating cavity A1 due to the gravity, so that the doorstop portion A4 is engaged with the recessed portion B4, and thus the optical-fiber plug B cannot be moved with respect to the mating cavity A1 of the optical-fiber adapter A. When the optical-fiber plug is to be detached from the optical-fiber adapter A, because the doorstop portion A4 is engaged with the recessed portion B4, the optical-fiber plug B cannot be directly detached from the optical-fiber adapter A; instead, the operator has to pull the optical-fiber plug B upward and backward, and then the optical-fiber plug B can be detached from the optical-fiber adapter A.

### SUMMARY OF THE INVENTION

In view of these considerations, one or some embodiments of the instant disclosure provide an optical-fiber adapter. The optical-fiber adapter comprises a base member and a door piece. The base member has a receiving groove and an insertion opening and comprises a doorstop portion. The insertion opening is in communication with the receiving groove, and the doorstop portion is at a bottom portion of the insertion opening. The door piece is in the receiving groove to selectively close or open the insertion opening. Each of two sides of the door piece has a pivot portion. Each of the pivot portions is adjacent to the doorstop portion and pivotally connected to a corresponding one of two side walls of the base member, and an outer surface of the door piece comprises a protrusion adjacent to the doorstop portion.

In some embodiments, the optical-fiber adapter is adapted to be mated with an optical-fiber plug, the optical-fiber plug has a connection body, and a bottom surface of the connection body is adapted to contact the doorstop portion. When the door piece closes the insertion opening, the door piece abuts against an inner surface of the doorstop portion, and the protrusion is relatively at a top portion of the doorstop portion and adjacent to an entrance of the insertion opening.

In some embodiments, the two side walls of the base member are at two sides of the insertion opening, each of the two sides walls has a thin wall portion and a thick wall portion, each of the thin wall portions is relatively adjacent to the doorstop portion, and a virtual shaft line is defined between the thin wall portions. When the door piece closes the insertion opening, the protrusion relatively is at the virtual shaft line, and each of the thick wall portions is away from the doorstop portion.

In some embodiments, the door piece sequentially comprises a first section and a second section from a direction adjacent to the pivot portions to a direction away from the pivot portions, and the protrusion is at the first section.

In some embodiments, the protrusion comprises an abutting portion. when the door piece is in a first position to close the insertion opening, the abutting portion faces the insertion portion, and the abutting portion is near to an entrance of the insertion opening as compared with the second section (in other words, in some embodiments, a distance between the abutting portion and the entrance of the insertion opening is less than a distance between the second section of the door piece and the entrance of the insertion opening). The optical-fiber adapter is adapted to be mated with an optical-fiber plug, the optical-fiber plug has a connection body, an insertion pin is exposed from a middle portion of a surface of the connection body, the surface of the connection body is adapted to contact the abutting portion, and a spacing is between the insertion pin and the second section.

In some embodiments, the protrusion comprises an attaching plane. When the door piece is in a second position to open the insertion opening, the optical fiber is adapted to be mated with an optical-fiber plug, the optical-fiber plug has a connection body, a bottom surface of the connection body is adapted to contact the attaching plane, and the bottom surface of the connection body, the attaching plane, and a surface of the doorstop portion are at a same plane and flush with each other.

In some embodiments, the door piece comprises an end portion at an edge of the second section, the end portion is adapted to contact a front portion of the bottom surface of the connection body, and the attaching plane is adapted to contact a rear portion of the bottom surface of the connection body.

In some embodiments, the protrusion is an elongated structure laterally arranged on the outer surface of the door piece, the protrusion has a first inclined plane, a second inclined plane, and an attaching plane, the attaching plane is connected between one of two ends of the first inclined plane and one of two ends of the second inclined plane, the other end of the first inclined plane is connected to the first section, the other end of the second inclined plane is connected to the second section, and a length of the first inclined plane is less than a length of the second inclined plane.

In some embodiments, from a cross-sectional view, the protrusion is a trapezoidal structure or a semi-circular structure, and the outer surface of the door piece comprises a plurality of the protrusions adjacent to the doorstop portion.

In some embodiments, the base member has a through groove in communication with the insertion opening and the receiving groove, and the base member comprises an assembling portion adjacent to one of the two side walls adjacent to the through groove. The optical-fiber adapter further comprises a supporting member, the supporting member comprises an elastic piece, the elastic piece is in the receiving groove and abuts against an inner surface of the door piece, the elastic piece has a supporting portion abutting against the recessed portion, and the supporting member comprises an engaging portion assembled with the assembling portion.

According to some embodiments of the instant disclosure, the protrusion is arranged on the door piece. Therefore, when the optical-fiber plug is inserted into the receiving groove of the optical-fiber adapter, the door piece is pushed, so as the door piece is rotated to the bottom portion of the receiving groove and to the bottom portion of the optical-fiber plug, and the protrusion abuts against the bottom surface of the connection body of the optical-fiber plug. Hence, because the protrusion abuts against the bottom surface of the connection body, the optical-fiber plug does not drop downward to the bottom portion of the receiving groove due to the gravity, so that the issue that the optical-fiber plug is stuck at the bottom portion of the receiving groove or at the doorstop portion (which will thus cause the detaching of the optical-fiber plug cannot be performed smoothly) can be prevented. According to some embodiments, when the optical-fiber plug is inserted into the receiving groove from the insertion opening of the optical-fiber adapter, the surface of the connection firstly contacts the protrusion, and a spacing is between the insertion pin and the door piece. Therefore, during the insertion, the insertion pin of the optical-fiber plug does not impact or contact the door piece.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a lateral cross-sectional view showing an optical-fiber adapter and an optical-fiber plug of a prior art known to the inventor are mated with each other;

FIG. 2 illustrates a perspective view of an optical-fiber adapter according to one embodiment of the instant disclosure, where the optical-fiber adapter has four insertion openings;

FIG. 3 illustrates a front view of an optical-fiber adapter according to one embodiment of the instant disclosure;

FIG. 4 illustrates a top exploded view of an optical-fiber adapter according to one embodiment of the instant disclosure;

FIG. 5 illustrates a bottom exploded view of an optical-fiber adapter according to one embodiment of the instant disclosure;

FIG. 6 illustrates a perspective view of a door piece according to one embodiment of the instant disclosure, where the protrusion on the door piece is an elongated structure;

FIG. 7 illustrates a lateral cross-sectional view showing an optical-fiber adapter is mating with an optical-fiber plug, according to one embodiment of the instant disclosure;

FIG. 8 illustrates a lateral cross-sectional view showing an optical-fiber adapter is mated with an optical-fiber plug, according to one embodiment of the instant disclosure;

FIG. 9 illustrates a perspective view of a door piece according to one embodiment of the instant disclosure, where the protrusion on the door piece is a semi-circular structure; and

FIG. 10 illustrates a perspective view of an optical-fiber adapter according to one embodiment of the instant disclosure, where the optical-fiber adapter has two insertion openings.

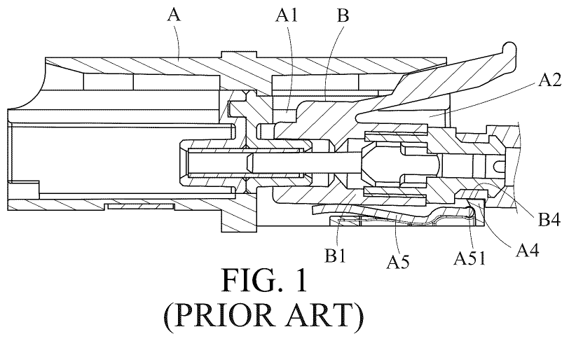

### DETAILED DESCRIPTION

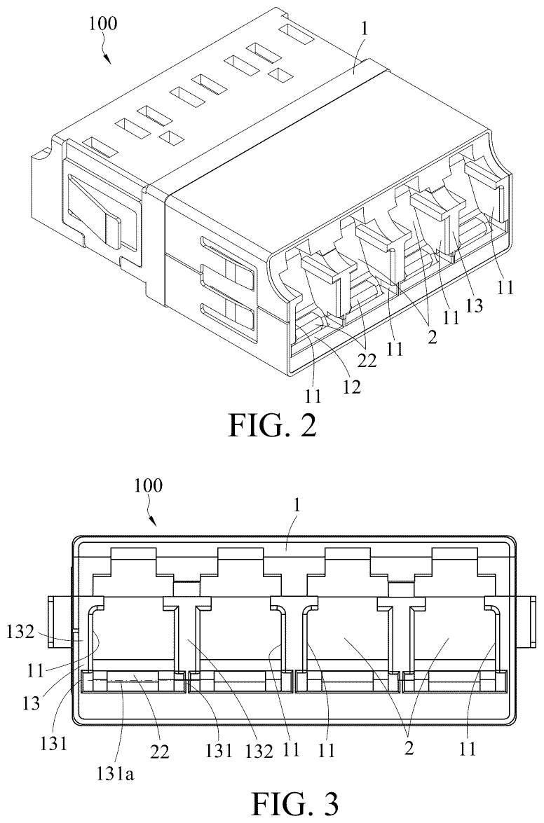

Please refer to FIG. 2. FIG. 2 illustrates a perspective view of an optical-fiber adapter 100. In some embodiments, the optical-fiber adapter 100 may be applied to data communication networks, cable TV networks, or optical-fiber communication networks, and the optical-fiber adapter 100 is applied for optical-fiber signal transmission of 4G/LTE/5G communication networks.

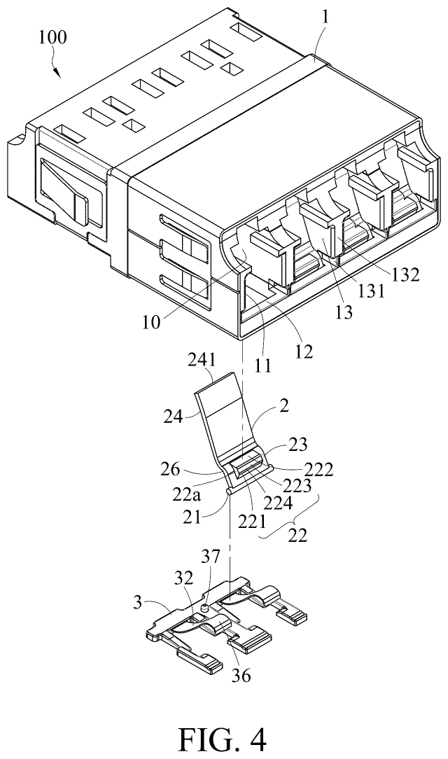

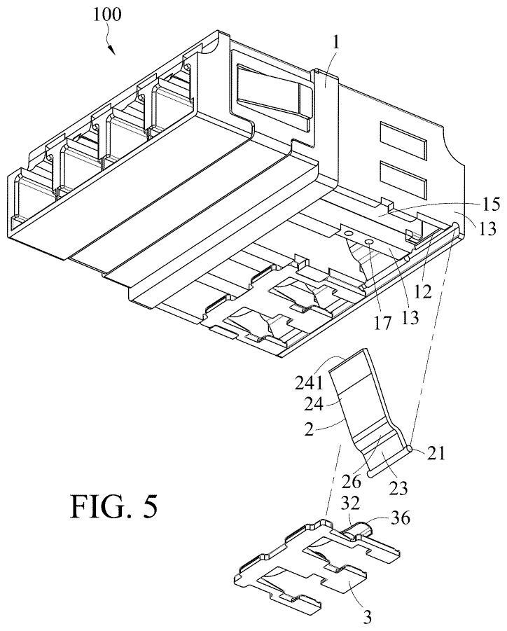

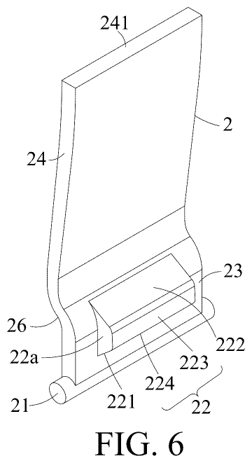

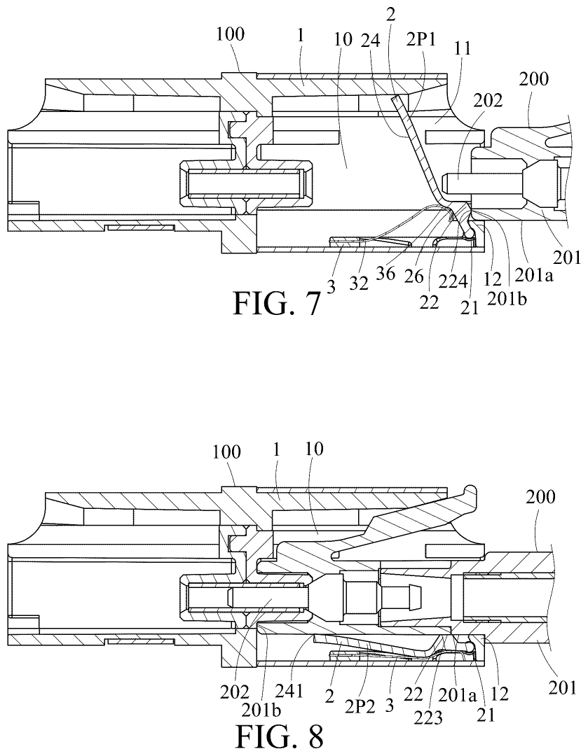

Please refer to FIG. 3 to FIG. 6. FIG. 3 illustrates a front view of an optical-fiber adapter 100, FIG. 4 illustrates a top exploded view of an optical-fiber adapter 100, FIG. 5 illustrates a bottom exploded view of an optical-fiber adapter 100, and FIG. 6 illustrates a perspective view of a door piece 2. In some embodiments, the optical-fiber adapter 100 comprises a base member 1 and a door piece 2. The base member 1 has a receiving groove 10 and an insertion opening 11, and the base member 1 comprises a doorstop portion 12. The insertion opening 11 is in communication with the receiving groove 10, and the doorstop portion 12 is at a bottom portion of the insertion opening 11. The door piece 2 is in the receiving groove 10 to selectively close the insertion opening 11 (as shown in FIG. 7) or open the insertion opening 11 (as shown in FIG. 8). Each of two sides of the door piece 2 has a pivot portion 21, and each of the pivot portions 21 is adjacent to the doorstop portion 12 and pivotally connected to a corresponding one of two side walls 13 of the base member 1. An outer surface of the door piece 2 comprises a protrusion 22 adjacent to the doorstop portion 12.

Please refer to FIG. 7 and FIG. 8. FIG. 7 illustrates a lateral cross-sectional view showing an optical-fiber adapter 100 is mating with an optical-fiber plug 200, and FIG. 8 illustrates a lateral cross-sectional view showing an optical-fiber adapter 100 is mated with an optical-fiber plug 200. In some embodiments, the optical-fiber adapter 100 is adapted to be mated with an optical-fiber plug 200. The optical-fiber plug 200 has a connection body 201 and an insertion pin 202, and the insertion pin 202 is exposed from a middle portion of a surface 201b of the connection body 201. When the optical-fiber plug 200 is inserted into the optical-fiber adapter 100 from the insertion opening 11, the surface 201b of the connection body 201 firstly contacts the protrusion 22, and a distance is between the insertion pin 202 and the door piece 2. Next, the optical-fiber plug 200 is further pushed to be inserted toward the receiving groove 10 of the optical-fiber adapter 100, and the insertion pine 202 does not contact or impact the door piece 2. At this moment, the door piece 2 is pushed, so that the door piece 2 is rotated by taking the pivot portions 21 as the rotation center. The door piece 2 is rotated and swung toward the interior and the bottom portion of the receiving groove 10, so that the protrusion 22 abuts against the bottom surface 201a of the connection body 201 of the optical-fiber plug 200. Therefore, because the protrusion 22 abuts against the bottom surface 201a of the connection body 201, the optical-fiber plug 200 does not drop downward to the bottom portion of the receiving groove 10 due to the gravity, so that the issue that the optical-fiber plug 200 is stuck at the bottom portion of the receiving groove 10 or at the doorstop portion 12 (which will thus cause the detaching of the optical-fiber plug 200 cannot be performed smoothly) can be prevented.

Please refer to FIG. 4 and FIG. 5. In some embodiments, the base member 1 is a rectangular hollowed shell. One of two ends of the base member 1 has an insertion opening 11, and the other end of the base member 1 has a mating opening. The bottom portion of the base member 1 has a through groove 15 in communication with the insertion opening 11 and the receiving groove 10, and the base member 1 comprises an assembling portion 17 at one of the two side walls 13 adjacent to the through groove 15.

In some embodiments, the number of the insertion opening 11 may be one or more. For example, in the embodiment shown in FIG. 10, the base member 1 of the optical-fiber adapter 100 has two insertion openings 11; in the embodiment shown in FIG. 2, the base member 1 of the optical-fiber adapter 100 has four insertion openings 11.

Please refer to FIG. 3 and FIG. 4. In some embodiments, the two side walls 13 of the base member 1 are at two sides of the insertion opening 11. Each of the two side walls 13 has a thin wall portion 131 and a thick wall portion 132. Each of the thin wall portions 131 is relatively adjacent to the doorstop portion 12, and a virtual shaft line 131a is defined between the thin wall portions 131. When the door piece 2 closes the insertion opening 11, the protrusion 22 is relatively at the virtual shaft line 131a, and each of the thick wall portions 132 is away from the doorstop portion 12. In some embodiments, when the door piece 2 closes the insertion opening 11, the door piece 2 abuts against an inner surface of the doorstop portion 12, and the protrusion 22 is relatively at a top portion of the doorstop portion 12 and adjacent to an entrance of the insertion opening 11.

Please refer to FIG. 4 and FIG. 7. In some embodiments, the optical-fiber adapter 100 further comprises a supporting member 3. The supporting member 3 comprises an elastic piece 32, the elastic piece 32 is in the receiving groove 10 and abuts against an inner surface of the door piece 2. The inner surface of the door piece 2 comprises a recessed portion 26, the elastic piece 32 has a supporting portion 36 abutting against the recessed portion 26. The supporting member 3 comprises an engaging portion 37 assembled with the assembling portion 17.

Please refer to FIG. 5. In some embodiments, the door piece 2 is a rectangular plate, each of two sides of one of two ends of the door piece 2 has a pivot portion 21, and the other end of the door piece 2 has an end portion 241. The door piece 2 sequentially comprises a first section 23 and a second section 24 from a direction adjacent to the pivot portions 21 to a direction away from the pivot portions 21. The first section 23 extends straightforward, and the second section 24 extends obliquely with respect to the first section 23. The protrusion 22 is at the first section 22, and the end portion 241 is at an edge of the second section 24 of the door piece 2.

Please refer to FIG. 5. In some embodiments, the number of the protrusion 22 may be one, and the protrusion 22 is an elongated structure laterally arranged on the outer surface of the door piece 2, but the instant disclosure is not limited thereto. In some embodiments, the door piece 2 may comprise a plurality of protrusions 22 (the number of the protrusion 22 may be plural), the protrusions 22 are spaced apart from each other, arranged on the outer surface of the door piece 2, and adjacent to the doorstop portion 12.

Please refer to FIG. 5. In some embodiments, from a cross-sectional view, the protrusion 22 is a trapezoidal structure 22a. The protrusion 22 has a first inclined plane 221, a second inclined plane 222, and an attaching plane 223. The attaching plane 223 is connected to one of two ends of the first inclined plane 221 and one of two ends of the second inclined plane 222, the other end of the first inclined plane 221 is connected to the first section 23, the other end of the second inclined plane 222 is connected to the second section 24, and a length of the first inclined plane 221 is less than a length of the second inclined plane 222.

Please refer to FIG. 4 and FIG. 7. In some embodiments, when the door piece 2 is in a first position 2P1, the door piece 2 is in the receiving groove 10. The protrusion 22 comprises an abutting portion 224, the abutting portion 225 is at a corner between the first inclined plane 221 and the attaching plane 223. When the door piece 2 is in the first position 2P1 to close the insertion opening 11, the door piece 2 in the first position 2P1 is inclined with respect to an entrance of the insertion opening 11, and the insertion opening 11 is closed. At this moment, the abutting portion 224 of the protrusion 22 faces the insertion opening, and the abutting portion 224 is nearer to the entrance of the insertion opening 11 as compared with the second section 24 of the door piece 2 (in other words, in some embodiments, a distance between the abutting portion 224 and the entrance of the insertion opening 11 is less than a distance between the second section 24 of the door piece 2 and the entrance of the insertion opening 11). Therefore, when the optical-fiber plug 200 is to be mated with the optical-fiber adapter 100 again, the optical-fiber plug 200 inserting into the insertion opening 11 firstly contacts the abutting portion 224 of the protrusion 22, so that the insertion pin 202 of the optical-fiber plug 200 does not contact or impact the door piece 2.

When the optical-fiber plug 200 is detached from the insertion opening 11 of the optical-fiber adapter 100, the inner surface of the door piece 2 is abutted by the resilient force of the supporting portion 36 of the elastic piece 32. Therefore, the door piece 2 is pushed and moved resiliently to the position where the insertion opening 11 is closed by the door piece 2. Hence, according to some embodiments, such configuration provides a dustproof function to prevent the interior of the optical-fiber adapter 100 from being contaminated, so that the durability of the optical-fiber adapter 100 can be enhanced and the service life of the optical-fiber adapter 100 can be prolonged. Accordingly, the receiving groove 10 can be kept clean to ensure reliable optical-fiber signal transmission.

Please refer to FIG. 4 and FIG. 8. In some embodiments, when the door piece 2 is in a second position 2P2, the door piece 2 is in the receiving groove 10. When the optical-fiber plug 200 is inserted into the receiving groove 10 of the optical-fiber adapter 100, the door piece 2 is pushed to the bottom portion of the receiving groove 10, and the door piece is in the second position 2P2 to open the insertion opening 11. The door piece 2 in the second position 2P2 is arranged horizontally and the door piece 2 is relatively perpendicular to the entrance of the insertion opening 11. Then, the bottom surface 201a of the connection body 201 of the optical-fiber plug 200 contacts the surface of the doorstop portion 12, so that the optical-fiber plug 200 does not drop downward to the bottom portion of the receiving groove 10. Therefore, the issue that the optical-fiber plug 200 is stuck at the receiving groove 10 or the doorstop portion 12 (which will thus cause the detaching of the optical-fiber plug 200 cannot be performed smoothly) can be prevented. Accordingly, the operation of the optical-fiber adapter 100 can be achieved conveniently.

Please refer to FIG. 4 and FIG. 8. In some embodiments, when the optical-fiber plug 200 is inserted into the receiving groove 10 of the optical-fiber adapter 100, the bottom surface 201a of the connection body 201 contacts the attaching plane 223 of the protrusion 22. The bottom surface 201a of the connection body 201, the attaching plane 223 of the protrusion 22, and the surface of the doorstop portion 12 are at the same plane and flush with each other. Therefore, the optical-fiber plug 200 does not drop downward to the bottom portion of the receiving groove 10. Hence, the issue that the optical-fiber plug 200 is stuck at the receiving groove 10 or the doorstop portion 12 (which will thus cause the detaching of the optical-fiber plug 200 cannot be performed smoothly) can be prevented. In some embodiments, the end portion 241 of the door piece 2 contacts a front portion of the bottom surface 201a of the connection body 201, and the attaching plane 223 of the door piece 2 contacts a rear portion of the bottom surface 201a of the connection body 201.

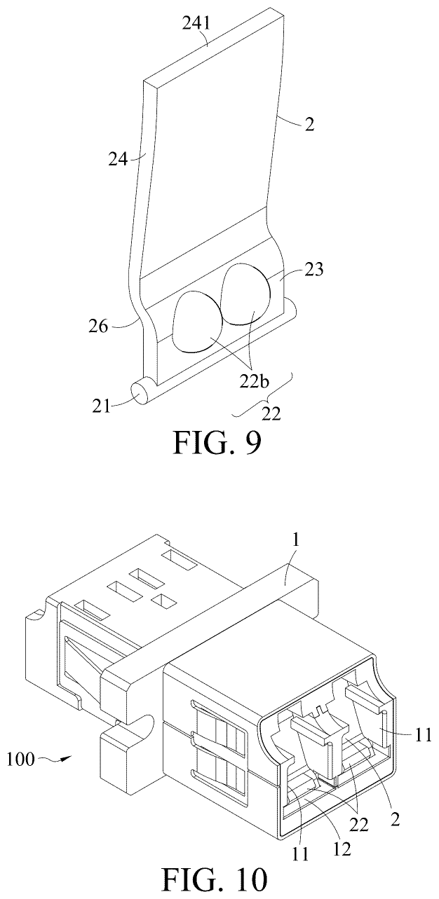

Please refer to FIG. 9. FIG. 9 illustrates a perspective view of a door piece 2. In some embodiments, from a cross-sectional view, the protrusion 22 is a semi-circular structure 22b. When the optical-fiber plug 200 is inserted into the receiving groove 10 of the optical-fiber adapter 100, the protrusion 22 having the semi-circular structure 22b abuts against the connection body 201 of the optical-fiber plug 200 through a point-contact manner.

Please refer to FIG. 9. In some embodiments, the door piece 2 may comprise a plurality of protrusions 22 (the number of the protrusion 22 may be plural), the protrusions 22 having the semi-circular structure 22b are spaced apart from each other, arranged on the outer surface of the door piece 2, and adjacent to the doorstop portion 12. When the optical-fiber plug 200 is inserted into the receiving groove 10 of the optical-fiber adapter 100, the protrusions 22 having the semi-circular structure 22b abut against the connection body 201 of the optical-fiber plug 200 through a point-contact manner, thereby allowing the contact between the optical-fiber adapter 100 and the optical-fiber plug 200 can be achieved properly.

According to some embodiments of the instant disclosure, the protrusion is arranged on the door piece. Therefore, when the optical-fiber plug is inserted into the receiving groove of the optical-fiber adapter, the door piece is pushed, so as the door piece is rotated to the bottom portion of the receiving groove and to the bottom portion of the optical-fiber plug, and the protrusion abuts against the bottom surface of the connection body of the optical-fiber plug. Hence, because the protrusion abuts against the bottom surface of the connection body, the optical-fiber plug does not drop downward to the bottom portion of the receiving groove due to the gravity, so that the issue that the optical-fiber plug is stuck at the bottom portion of the receiving groove or at the doorstop portion (which will thus cause the detaching of the optical-fiber plug cannot be performed smoothly) can be prevented. According to some embodiments, when the optical-fiber plug is inserted into the receiving groove from the insertion opening of the optical-fiber adapter, the surface of the connection firstly contacts the protrusion, and a spacing is between the insertion pin and the door piece. Therefore, during the insertion, the insertion pin of the optical-fiber plug does not impact or contact the door piece.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An optical-fiber adapter, comprising:
a base member having a receiving groove and an insertion opening and comprising a doorstop portion, wherein the insertion opening is in communication with the receiving groove, and the doorstop portion is at a bottom portion of the insertion opening; and
a door piece at the receiving groove to selectively open or close the insertion opening, wherein each of two sides of the door piece has a pivot portion, each of the pivot portions is adjacent to the doorstop portion and pivotally connected to a corresponding one of two side walls of the base member, and an outer surface of the door piece comprises a protrusion adjacent to the doorstop portion.

2. The optical-fiber adapter according to claim 1, wherein the optical-fiber adapter is adapted to be mated with an optical-fiber plug, the optical-fiber plug has a connection body, and a bottom surface of the connection body is adapted to contact the doorstop portion; when the door piece closes the insertion opening, the door piece abuts against an inner surface of the doorstop portion, and the protrusion is relatively at a top portion of the doorstop portion and adjacent to an entrance of the insertion opening.

3. The optical-fiber adapter according to claim 2, wherein the two side walls of the base member are at two sides of the insertion opening, each of the two side walls has a thin wall portion and a thick wall portion, each of the thin wall portions is relatively adjacent to the doorstop portion, and a virtual shaft line is defined between the thin wall portions; when the door piece closes the insertion opening, the protrusion is relatively at the virtual shaft line, and each of the thick wall portions is away from the doorstop portion.

4. The optical-fiber adapter according to claim 1, wherein the door piece sequentially comprises a first section and a second section from a direction adjacent to the pivot portions to a direction away from the pivot portions, and the protrusion is at the first section.

5. The optical-fiber adapter according to claim 4, wherein the protrusion comprises an abutting portion; when the door piece is in a first position to close the insertion opening, the abutting portion faces the insertion portion, and the abutting portion is nearer to an entrance of the insertion opening as compared with the second section; the optical-fiber adapter is adapted to be mated with an optical-fiber plug, the optical-fiber plug has a connection body, an insertion pin is exposed from a middle portion of a surface of the connection body, the surface of the connection body is adapted to contact the abutting portion, and a spacing is between the insertion pin and the second section.

6. The optical-fiber adapter according to claim 4, wherein the protrusion comprises an attaching plane; when the door piece is in a second position to open the insertion opening, the optical-fiber adapter is adapted to be mated with an optical-fiber plug, the optical-fiber plug has a connection body, a bottom surface of the connection body is adapted to contact the attaching plane, and the bottom surface of the connection body, the attaching plane, and a surface of the doorstop portion are at a same plane and flush with each other.

7. The optical-fiber adapter according to claim 6, wherein the door piece comprises an end portion at an edge of the second section, the end portion is adapted to contact a front portion of the bottom surface of the connection body, and the attaching plane is adapted to contact a rear portion of the bottom surface of the connection body.

8. The optical-fiber adapter according to claim 4, wherein the protrusion is an elongated structure laterally arranged on the outer surface of the door piece, the protrusion has a first inclined plane, a second inclined plane, and an attaching plane, the attaching plane is connected between one of two ends of the first inclined plane and one of two ends of the second inclined plane, the other end of the first inclined plane is connected to the first section, the other end of the second inclined plane is connected to the second section, and a length of the first inclined plane is less than a length of the second inclined plane.

9. The optical-fiber adapter according to claim 1, wherein from a cross-sectional view, the protrusion is a trapezoidal structure or a semi-circular structure, and the outer surface of the door piece comprises a plurality of the protrusions adjacent to the doorstop portion.

10. The optical-fiber adapter according to claim 1, wherein the base member has a through groove in communication with the insertion opening and the receiving groove, and the base member comprises an assembling portion adjacent to one of the two side walls adjacent to the through groove; the optical-fiber adapter further comprises a supporting member, the supporting member comprises an elastic piece, the elastic piece is in the receiving groove and abuts against an inner surface of the door piece, the inner surface of the door piece comprises a recessed portion, the elastic piece has a supporting portion abutting against the recessed portion, and the supporting member comprises an engaging portion assembled with the assembling portion.
